(19) United States
(12) Patent Application Publication
(10) Pub. No.: US 2016/0181643 A1
(43) Pub. Date: Jun. 23, 2016

(54) METHOD FOR FABRICATING ELECTROLYTE MEMBRANE USING IN-SITU CROSS-LINKING

(71) Applicants: AUDI AG, Ingolstadt (DE); THE BOARD OF TRUSTEES OF THE UNIVERSITY OF ALABAMA THE UNIVERSITY OF ALABAMA, Tuscaloosa, AL (US); TOYOTA JIDOSHA KABUSHIKI KAISHA, Toyota-shi (JP)

(72) Inventors: Zhiwei YANG, Vernon, CT (US); Mallika GUMMALLA, Longmeadow, MA (US); Joseph S. THRASHER, Seneca, SC (US); Yoichi HOSOKAWA, Ann Arbor, MI (US)

(21) Appl. No.: 14/910,654

(22) PCT Filed: Aug. 6, 2013
(86) PCT No.: PCT/US2013/053692

§ 371 Date: Feb. 5, 2016

(51) Int. Cl. H01M 8/1072; H01M 8/1039

(52) U.S. Cl. CPC H01M 8/1072; H01M 8/1039; H01M 2300/0082

(57) ABSTRACT

A method of fabricating an electrolyte membrane includes providing a reinforcement substrate that has impregnated therein a linear perfluorinated electrolyte polymer resin, and cross-linking the electrolyte polymer resin in-situ in the reinforcement substrate to thereby form a reinforced electrolyte membrane with cross-linked perfluorinated electrolyte polymer material impregnated therein.

### BACKGROUND

This disclosure relates to polymer electrolyte membranes and materials, such as those used in proton exchange membrane (“PEM”) fuel cells.

Fuel cells are commonly used for generating electric current. A single fuel cell typically includes an anode catalyst, a cathode catalyst, and an electrolyte between the anode and cathode catalysts, for generating an electric current in a known electrochemical reaction between a fuel and an oxidant. The electrolyte may be a polymer membrane, which is also known as a proton exchange membrane.

One common type of polymer exchange membrane is per-fluorinated sulfonic acid (“PFSA”), such as NAFION® (E. I. du Pont de Nemours and Company). PFSA has a perfluorinated carbon-carbon backbone with perfluorinated side chains. Each side chain terminates in a sulfonic acid group that serves as a proton exchange site to transfer or conduct protons between the anode and cathode catalysts.

The proton conductivity of PFSA polymers varies in relation to relative humidity (RH) and temperature. The relation between conductivity and level of hydration is based on two different mechanisms of proton transport. One mechanism is a vehicular mechanism, where the proton transport is assisted by the water in the polymer. The other mechanism is a hopping mechanism, where the proton hops along the sulfonic acid sites. While the vehicular mechanism is dominant at high relative humidity conditions, the hopping mechanism becomes important at low relative humidity conditions.

PEM fuel cells, especially for automobile applications, are required to be able to operate at high temperature (≧100° C.) and low RH (≦25% RH) conditions, in order to reduce the radiator size, simplify the system construction and improve overall system efficiency. Consequently, PEM materials with high proton conductivity at high temperature and low RH conditions are needed.

PFSA polymer is usually prepared by free radical copolymerization of tetrafluoroethylene (“TFE”) and per-fluorinated (“per-F”) vinyl ether monomer (such as perfluoro-2-(2-fluorosulfonylethoxy) propyl vinyl ether, or “PSEPVE”, for NAFION®). An indicator of conductivity of an electrolyte material is equivalent weight (“EW”), or grams of polymer required to neutralize 1 mol of base. One approach to produce a PFSA polymer with improved proton conductivity is to decrease the equivalent weight of the polymer by decreasing TFE content in the product polymer. The most common equivalent weights of commercially available PFSA polymer membranes (such as NAFION®) are between ˜800 and ˜1100 g/mol, which provide a balance between conductivity and mechanical properties. While PFSA polymer with EW in this range is needed, increasing conductivity below a certain EW threshold, such as below ˜750 g/mol, renders the electrolyte water soluble and unsuitable for PEM applications.

Per-F sulfonimide (SI) acids (such as CF₃—SO₂—NH—SO₂—CF₃) show favorable properties, including strong acidity, excellent chemical and electrochemical stability, for PEM fuel cell applications. Linear per-F sulfonimide polymers (“PFSI”), prepared by copolymerization of TFE and SI-containing per-F vinyl ether monomer, were first reported by DesMarteau, et al. (U.S. Pat. No. 5,463,005). Such type of linear PFSI polymers with EW in the range of 1175-1261 g/mol for PEM application was also reported by Creager, et al. (Polymeric materials: science and engineering—WASHINGTON—80, 1999: 600). Per-F vinyl ether monomer that contains two SI groups was also synthesized, and the corresponding linear PFSI polymer with the EW of 1175 g/mol was prepared and demonstrated to have high thermal and chemical stability in PEM fuel cell operating conditions (Zhou, Ph.D. thesis 2002, Clemson University). Reducing TFE content in the PFSI polymers is an efficient way to increase the proton conductivity of the product polymers. Linear PFSI polymer with the EW as low as 970 g/mol was reported in the literature (Xue, thesis 1996, Clemson University). However, such type of linear PFSI polymers with even lower EW is difficult to synthesize through free-radical copolymerization and also renders the polymer water soluble below a certain EW threshold.

The preparation of PFSI polymer with calculated EW of ˜1040 by chemical modification of PFSA polymer resin (in —SO₂—F form) was reported in a Japanese patent (Publication No: 2002212234). Furthermore, a more efficient chemical modification process was reported by Hamrock et al. (Publication No. WO 2011/129967). In this process, a linear PFSA polymer resin (in —SO₂—F form) was treated with ammonia in acetonitrile (“ACN”) to convert the —SO₂—F groups to sulfonamide (—SO₂—NH₂) groups, which then reacted with a per-F disulfonyl difluoride compound (such as F—SO₂—(CF₂)₃—SO₂—F) to convert to —SI—(CF₂)₃—SO₃H in the final product. By starting with a 3M's PFSA resin (in —SO₂—F form) with EW of ˜800 g/mol, water-insoluble polymer electrolyte with EW as low as ˜625 g/mol was reported. However, polymer electrolyte with even lower EW (<625 g/mol) resulted in a water soluble polymer and hence is not suitable for PEM applications.

Cross-linking is known as an effective strategy to prevent polymers from being soluble in water and organic solvents. This strategy is known to improve mechanical strength. Cross-linking PFSA polymer can be achieved by a coupling reaction of a sulfonyl fluoride (—SO₂—F) group and a sulfonamide (N₂H—SO₂—) group to form a sulfonimide acid (—SO₂—NH—SO₂—) as a cross-linking site. The resulting sulfonimide group also works as a proton conducting site.

Uematsu et al. (Journal of Fluorine Chemistry 127 (2006) 1087-1095) reported using thermal treatment (270° C.) to couple sulfonyl fluoride groups and sulfonamide groups in terpolymers of TFE, PSEPVE and sulfonamide-containing per-F vinyl ether monomer to form SI groups as cross-linking sites in the polymer matrix. An improvement in mechanical strength of polymer matrix was shown, without reduction in equivalent weight.

Hamrock et al. (US2009/041614, US2006/0160958, US2005/0113528, U.S. Pat. No. 7,060,756, EP1690314) proposed to use aromatic cross-linking agents to react with PFSA polymer (in —SO₂—F and/or —SO₂-C1 form) to generate aromatic sulfone-containing cross-links in the polymer matrix. The proposed reaction conditions include thermal treatment at high temperature (160° C. or higher) and with a Lewis acid as catalyst. The proposed product polymer may have EW lower than 900 g/mol. The even lower EW (≦700 g/mol) cross-linked polymer products were not mentioned in these patents. In addition, the introduction of aromatic ring structures into the polymer matrix compromised chemical stability and could lead to inferior durability of product polymer membranes in highly acidic and highly oxidizing conditions in PEM fuel cells.

Lower EW cross-linked electrolyte materials offer enhanced mechanical strength and higher conductivity; however, a fully cross-linked polymer, e.g., rubber, is not further deformable, limiting the viability for making free-standing electrolyte membranes from the cross-linked electrolyte materials, and it's even challenging for fabricating porous mat reinforced electrolyte membranes.

### SUMMARY

An example method of fabricating an electrolyte membrane includes providing a reinforcement substrate that has impregnated therein a linear perfluorinated electrolyte polymer resin, and cross-linking the electrolyte polymer resin in-situ in the reinforcement substrate to thereby form a reinforced electrolyte membrane with cross-linked perfluorinated electrolyte polymer material impregnated therein.

### DETAILED DESCRIPTION

The disclosed example proton exchange polymer materials, also known as ionomers, can be used as proton exchange membranes for PEM fuel cells or other applications where proton exchange is desirable. A proton exchange polymer material can be incorporated into a reinforcement substrate, such as a porous or fibrous mat, to provide a mechanically reinforced membrane. Cross-linked perfluorinated ionomer materials may not be easily infiltrated into a reinforcement substrate because the use of high temperature to make the ionomer flow into the substrate instead results in chemical decomposition of the ionomer and reinforcement substrate. Moreover, to the extent that the cross-linked ionomer is infiltrated into the substrate, the yield can be low, resulting in undesired voids in the membrane. The approach described herein however, infiltrates a linear perfluorinated electrolyte polymer resin into a reinforcement substrate and then cross-links the polymer resin in-situ in the substrate. The linear perfluorinated electrolyte polymer resin can be more easily infiltrated into the substrate and thus a higher yield and fewer voids are expected.

An example method of fabricating a reinforced electrolyte membrane includes providing a reinforcement substrate that has a linear perfluorinated electrolyte polymer resin impregnated therein, and cross-linking the linear perfluorinated electrolyte polymer resin, in-situ in the reinforcement substrate, to form the membrane with cross-linked perfluorinated ionomer material impregnated therein. As can be appreciated, the disclosed steps can be used in combination with other processing steps as appropriate to produce a desired membrane.

In one example, the cross-linked perfluorinated ionomer material has an equivalent weight of 750 g/mol or less. In a further example, the cross-linked perfluorinated ionomer material includes a perfluorinated sulfonimide polymer. In a further example, the reinforcement substrate is a porous substrate, such as a porous or fibrous mat of polytetrafluoroethylene (“PTFE”), polyethylene, or polyvinylidene difluoride (“PVDF”).

In a further example, the cross-linked perfluorinated ionomer material includes perfluorinated carbon-carbon backbone chains and perfluorinated side chains extending off of the perfluorinated carbon-carbon backbone chains via an ether linkage. The perfluorinated side chains have one or more sulfonimide (SI) groups, —SO₂—NH—SO₂—.

In embodiments, the cross-linked perfluorinated ionomer material has a structure of —(CF₂—CF₂)_{N}—CF₂—CF(—O—R_{A}—R_{B})—, where —(CF₂—CF₂)_{N}—CF₂—CF— represents the polymer backbone chains and N, on average, is greater than or equal to zero, —O—R_{A}—R_{B} represents the side chains that extend off of the backbone chains, wherein R_{A} is a linear or branched perfluorinated chain, which includes a general structure of —C_{X}F_{2X}O_{Y}—, where X is greater than or equal to two and Y is greater than or equal to zero. R_{B} is a linear or branched perfluorinated chain, which contains one or more SI groups and ends with a —CF₃ group, or a —SO₃H group, or covalently links to another R_{A} in a different side chain.

In embodiments, the side chains that extend off of the backbone chains has cross-link chains, but may also have end-capped chains. The end-capped chains can have at least one SI group, —SO₂—NH—SO₂—, and can include between two and five of SI groups or even greater than five SI groups. Additionally, the end-capped chains can terminate with a —CF₃ group or a —SO₃H group. The portion of end-capped chains that terminate with —CF₃ may include multiple SI groups, and the portion of end-capped chains that terminate with —SO₃H can include at least one SI group. The cross-link chains can contain at least two SI groups and covalently link to the same or different polymer backbone chains.

In a further example, 20-99% of the perfluorinated side chains are end-capped chains and 80-1% of the side chains are cross-link chains. In other examples, 50-99% of the perfluorinated side chains are end-capped chains and 50-1% of the side chains are cross-link chains.

In one example, the cross-linked perfluorinated ionomer material has Structure 1 shown below, where N, on average, is greater than or equal to zero, R_{A} is a linear or branched perfluorinated chains, which includes a general structure of —C_{X}F_{2X}O_{Y}—, where X is greater than or equal to two and Y is greater than or equal to zero. SI is sulfonimide group. It is also understood that the end-capped chains and cross-link chains may occur randomly on the perfluorinated carbon-carbon backbone chains. The amounts of end-capped chains and cross-link chains may be as described above.

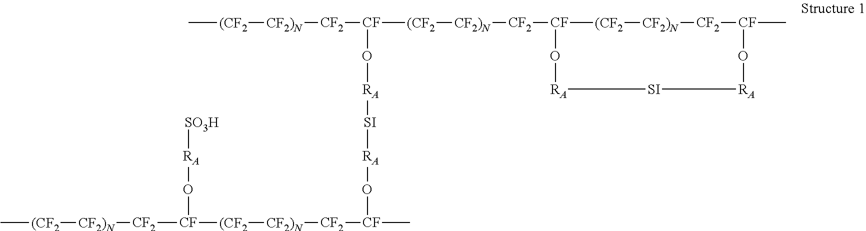

In another example, the cross-linked perfluorinated ionomer material has Structure 2 shown below, where N, on average, is greater than or equal to zero, R_{A} is a linear or branched perfluorinated chains, which includes a general structure of —C_{X}F_{2X}O_{Y}—, where X is greater than or equal to two and Y is greater than or equal to zero. SI is sulfonimide group, R_{C1}, R_{C2} and R_{C3} are independently selected from —(CF₂)_{y}— where y is 1-6 and —(CF₂)_{y′}—O—(CF₂)_{3′}— where y′ is 1-4, m, m′, n and n′ are greater than or equal to 1. The coefficients m, m′, n and n′ may be equal to or different than each other, z is greater than or equal to zero. It is also understood that the end-capped chains and cross-link chains may occur randomly on the perfluorinated carbon-carbon backbone chains. The amounts of end-capped chains and cross-link chains may be as described above.

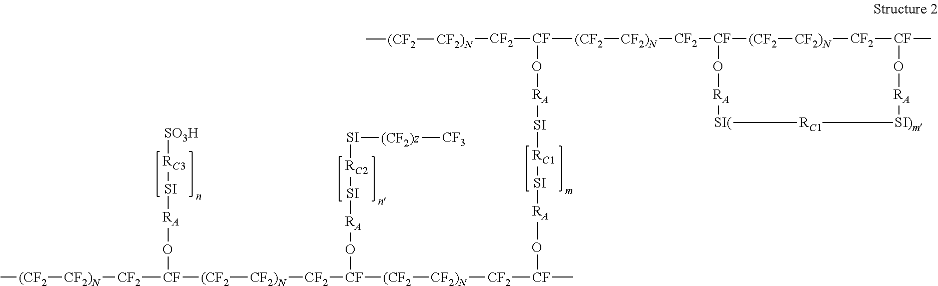

A user may design cross-linked perfluorinated ionomer material with a selected number of SI groups, backbone structure and side chain structure to provide a desired EW of proton exchange sites.

In further examples, the equivalent weight of the cross-linked perfluorinated ionomer material is less than 700, and in additional examples can be less than 625. The disclosed ranges provide relatively high proton conductivity and a suitable rheology for membranes and electrode ionomers desired for a PEM fuel cell or other applications.

In a further example, the method includes infiltrating the linear perfluorinated ionomer material into the reinforcement substrate. In this regard, the method can utilize either of two different approaches. The two approaches are described in more detail below.

Approach I

Approach I produces cross-linked perfluorinated ionomer materials having a general chemical structure as described in Structure 1 above. Approach I can generally include four steps, briefly summarized as follows:

(A) Polymerization: free radical polymerization to produce a linear PFSA polymer resin (in —SO₂—F form),

(B) infiltration: impregnate the polymer resin from (A) into a reinforcement substrate,

(C) conversion: in-situ in the reinforcement substrate, converting only a portion of the —SO₂—F groups in the polymer resin from (A) to sulfonamide groups, —SO₂—NH₂, and

(D) cross-linking: in-situ in the reinforcement substrate, conducted in a solid-gas phase reaction where the polymer resin is processed in a solid state rather than being dissolved in a liquid solvent and an amine is used as catalyst in a vapor phase.

In further examples, the polymerization of step (A) includes co-polymerization of tetrafluoroethylene and per-F vinyl ether monomer that includes, but is not limited to, PSEPVE and perfluoro 3-oxa-4-pentene-sulfonylfluoride (CF₂═CF—O—CF₂CF₂—SO₂—F). The ratio of tetrafluoroethylene to per-F vinyl ether monomer in the product polymer resin is between zero and four.

In a further example, the infiltration step (B) includes solution infiltration or melting infiltration. The solution infiltration involves dissolving the linear PFSA polymer resin (in —SO₂—F form) in a carrier fluid, such as CF₃—CHF—CHF—CF₂—CF₃ (VERTREL® HFC-43-10 by E.I. du Pont de Nemours and Company), per-F hexane or similar solvent, and casting the solution into the reinforcement substrate. The carrier fluid is then removed, such as by evaporation, to deposit the linear PFSA polymer resin in the reinforcement substrate. The melting infiltration involves placing the linear PFSA polymer resin (in —SO₂—F form) on the reinforcement substrate and then heating to melting point of the polymer resin such that the melted polymer resin infiltrates into the reinforcement substrate. Melting infiltration can be carried out by a manual reel system. The PTFE mat was attached to a glass rod on the both edges and was immersed into melted polymer resin with heating on a digital heater. With this continuous process and conditions, a composite membrane was smoothly taken out.

In a further example, the conversion step (C) includes exposing the reinforcement substrate and linear PFSA polymer resin (in —SO₂—F form) to ammonia gas. As an example, the gas pressure, reaction temperature, and reaction time can be controlled to provide a desirable portion of —SO₂—F groups to convert to sulfonamide groups, —SO₂—NH₂.

In a further example of steps (B) and (C), PSEPVE homopolymer was melted at high temperature (120-160° C.) and was used to impregnate a porous PTFE mat. Then the impregnated mat was treated with 1 atm of NH₃ gas at room temperature roughly 1 hour to form the necessary amount of —SO₂—NH₂ groups in the polymer for the consequent cross-linking reaction.

In a further example, the cross-linking step (D) includes exposing the reinforcement substrate and partially converted PFSA polymer resin that contains both —SO₂—F and —SO₂—NH₂ groups to amine catalyst vapor. The amine catalyst includes, but is not limited to, trimethylamine (“TMA”), triethylamine (“TEA”), N,N-Diisopropylethylamine (“DIPEA”), and combinations thereof. In further examples, the cross-linking reaction can also be carried out in the presence of a polar solvent vapor. For example, the solvent vapor includes, but is not limited to, acetonitrile (“ACN”), 1,4-dioxane, dimethylformamide (“DMF”), N-methyl-2-pyrrolidone (“NMP”), and combinations thereof.

In a further example using TMA as catalyst, the treatment can be conducted at 1 atm of TMA gas at 80-100° C. for 1 week. In the TEA/1,4-dioxane method, the treatment can be conducted in a TEA/1,4-dioxane mixture vapor (3/5 volume ratio) at 80° C. for 12 hours. In one example using TMA vapor alone, there was incomplete conversion of sulfonamide group to sulfonimide group. In one example using TMA/1,4-dioxane mixture vapor, no sulfonamide groups were observed in IR spectra. This may be due to the low gas permeability of TMA in the polymer matrix, and the solvent vapor swells the polymer and introduces more TMA in the polymer matrix.

Isolated cross-linked polymer yield strongly depends on the amidification time, shown in Table 1 below. The maximum yield was about 90%. However, it has been indicated that all isolated cross-linked polymer obtained had almost the same structure. Although the amidification degrees/isolated yields were different, the IR spectra of all isolated cross-linked polymers were nearly the same. This could be due to the low molecular weight and/or low EW polymer without enough cross-linking structure was removed during work-up.

TABLE 1

| | Amidification Time in | Cross-linked polymer's |
|---|---|---|
| Run | ammonia gas (hour) | isolated yield (%) |
| 1 | 0.5 | 74 |
| 2 | 0.25 | 48 |
| 3 | 0.125 | 18 |
| 4 | 0.0625 | 9 |
| 5 | 1 | 90 |
| 6 | 1.5 | 70 |

Furthermore, a PTFE composite membrane preparation using the conditions of Run 1 in Table 1 was performed. The composite membrane had an observed weight increase of 260%, a water uptake of 105%, and about 30% of swelling (MD: 32%, TD: 33%).

Approach II

Approach II produces cross-linked perfluorinated ionomer materials having a general chemical structure as described in Structure 2 above. Approach II can generally include four steps, briefly summarized as follows:

(A) Polymerization: free radical polymerization to produce a linear PFSA polymer resin (in —SO₂—F form),

(B) conversion: ex-situ outside of the reinforcement substrate, convert all the —SO₂—F groups to sulfonamide groups, —SO₂—NH₂,

(C) infiltration: impregnate the polymer from (B) and at least one cross-linking agent into a reinforcement substrate, and

(D) cross-linking: in-situ in the reinforcement substrate, conducted in a solid-gas phase where the polymer resin is processed in a solid state rather than being dissolved in a liquid solvent and an amine is used as catalyst in a vapor phase.

In a further example, the conversion of step (B) includes exposing the linear polymer resin (in —SO₂—F form) to ammonia gas. As an example, the gas pressure, temperature, and time can be controlled to provide a desirable conversion rate of the —SO₂—F groups to the sulfonamide groups, —SO₂—NH₂. In one further example, the gas pressure, temperature, and time are controlled to fully convert all —SO₂—F groups to sulfonamide groups, —SO₂—NH₂.

In a further example, the use of the ammonia gas permits the amidification to be conducted in a solvent-free process where the linear polymer resin is processed in a solid state rather than being dissolved in a liquid solvent solution. Prior to the exposing of the linear polymer resin (in —SO₂—F) to ammonia gas, the particle size of the polymer resin can be decreased using, but not limited to, cryo-grinding. The particle size reduction increases the contact surface area of the polymer with the ammonia gas and, therefore, reduces the reaction time and improves the reaction yield. The elimination of the solvent provides (i) a relatively clean reaction that reduces undesired by-products from side reactions with the solvent and (ii) easier collection of the product by simplifying product work-up. The following illustrate further examples of the amidification using ammonia gas, which can also be conducted in a solution (solvent) process.

### Example II(B)-1 (Amidification of PSEPVE Homopolymer)

For the PSEPVE homopolymer was placed in a round-bottomed flask and heated slowly under vacuum until the polymer started to flow. Then the flask was rotated to form a thin film of the homopolymer on the internal surface of the flask. The reaction flask was cooled down and ammonia gas was added to reach 1 atm pressure. The ammonia was added from time to time to keep constant pressure of 1 atm in the reaction flask.

For the work-up, one of two methods below were applied:

1) Product was extracted by dry ACN, the solvent was evaporated and the product was dried at 100-120° C. under vacuum; and

2) Product was dissolved in an organic solvent, including but not limited to ethyl acetate or diethyl ether, and washed with water. The solution was dried over MgSO₄, the solvent was evaporated and the product was dried at 100-120° C. under vacuum.

The second method allowed for the removal of all NH₄F from the polymer product. Starting from 3.5 g of PSEPVE homopolymer (7.85 mmol, in —SO₂—F form), 2.91 g of polymer product (in —SO₂—NH₂ form) was obtained with 84% yield.

### Example II(B)-2 (Amidification of PSEPVE Homopolymer)

6.67 g of PSEPVE homopolymer (in —SO₂—F form) was added to a flask and gaseous ammonia was added at 20° C. As ammonia was consumed, more was added to keep the pressure constant at 15 psig for 3 days. NH₄F was removed at 100° C. and 20 mtorr. Dry ACN was added to the resulting polymer and heated at 80° C. for 12 hours to dissolve the polymer. The solution was decanted off and the ACN was removed by distillation to yield 5.78 g of polymer product (in —SO₂—NH₂ form). The polymer product is well soluble in polar organic solvents, with a solubility of 100 mg/mL in ACN.

### Example II(B)-3 (Amidification of TFE-PSEPVE Copolymer)

4.00 g of the copolymer of PSEPVE and TFE with an EW of 775 was added to a Ni autoclave and NH₃ was added and maintained at 30 psig and 20° C. for 12 hours. The NH₄F produced was removed by vacuum distillation at 100° C. and 20 mtorr. Two aliquots of 150 mL dry ACN was added and heated to 80° C. to dissolve the sulfonamide polymer product. The solution was decanted off and the ACN was removed by distillation to yield 3.46 g of polymer product (in —SO₂—NH₂ form). The polymer is soluble in polar organic solvents, with a solubility of 10 mg/mL in ACN and 25 mg/mL in N-methyl-2-pyrrolidinone.

### Example II(B)-4 (Solution Amidification)

An amount of 6.52 g of the copolymer of TFL and PSEPVE is dissolved in refluxing perfluorohexane. Ammonia is bubbled through the solution to maintain a high reflux rate for several hours at room temperature. The ammonia is allowed to boil away and the volatiles, including ammonium fluoride, are all removed by heating to 110° C. at 50 mtorr. Dry ACN is then added to the flask and heated to refluxing. After three extractions with ACN, 5.67 g of white product is obtained in 87% yield.

In a further example, the infiltration of step (C) includes solution infiltration. In one example, the solution infiltration involves dissolving the polymer (in —SO₂—NH₂ form) from step (B) and at least one cross-linking agent in a carrier fluid. The carrier fluid can include ACN, 1,4-dioxane, DMF, NMP, and combinations thereof. The cross-linking agent can include F—SO₂—Rf—SO₂—F and, optionally, NH₂—SO₂—Rf′—SO₂—NH₂, where Rf and Rf′ are independently selected from —(CF₂)ₙ— where n is 1-6, or —(CF₂)ₙ—O—(CF₂)ₙ— where n′ is 1-4. In further examples n is equal to or different than n′. The solution is then cast into the reinforcement substrate. The carrier fluid is then removed, such as by evaporation, to deposit the polymer (in —SO₂—NH₂ form) and the cross-linking agent in the reinforcement substrate.

As described above, the polymerization of step (A) in Approach II also includes co-polymerization of tetrafluoroethylene and per-F vinyl ether monomer that includes, but not limited to, PSEPVE and perfluoro 3-oxa-4-pentene-sulfonylfluoride (CF₂═CF—O—CF₂CF₂—SO₂—F). In further examples, the ratio of tetrafluoroethylene to per-F vinyl ether monomer is between zero and four. Additionally, the cross-linking of step (D) is also conducted by exposing the reinforcement substrate with polymer (in —SO₂—NH₂ form) and cross-linking agents to a gas-phase amine catalyst, and optionally, in the presence of polar solvent vapor, to directly generate cross-linked polymer electrolyte in reinforcement substrate. The selection of amine catalyst and solvents, as well as reaction conditions, is as described above.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1. A method of fabricating an electrolyte membrane, the method comprising:
providing a reinforcement substrate that has impregnated therein a linear perfluorinated polymer resin; and
cross-linking the linear perfluorinated polymer resin in-situ in the reinforcement substrate to thereby form an reinforced electrolyte membrane with cross-linked perfluorinated ionomer material impregnated therein.

2. The method as recited in claim 1, wherein the cross-linked perfluorinated ionomer material has an equivalent weight of 750 g/mol or less with respect to proton exchange acid groups.

3. The method as recited in claim 1, wherein the cross-linked perfluorinated ionomer material includes perfluorinated sulfonimide polymer.

4. The method as recited in claim 1, wherein the reinforcement substrate is a porous polymeric mat.

5. The method as recited in claim 4, wherein the porous polymeric mat is a porous perfluorinated polymer mat.

6. The method as recited in claim 4, wherein the porous polymeric mat is a partially fluorinated polymer porous mat or a non-perfluorinated polymer porous mat.

7. The method as recited in claim 1, wherein the linear perfluorinated polymer resin has a perfluorinated carbon-carbon backbone, to which are attached perfluorinated side chains, the perfluorinated side chains terminating in a —SO₂—F group or a —SO₂—NH₂ group.

8. The method as recited in claim 1, wherein the cross-linking includes exposing the reinforcement substrate that has the impregnated linear polymer resin to a catalyst vapor.

9. The method as recited in claim 8, wherein the catalyst vapor is an amine vapor selected from the group consisting of trimethylamine, triethylamine, N,N-Diisopropylethylamine and combinations thereof.

10. The method as recited in claim 8, including adding a polar solvent vapor selected from the group consisting of acetonitrile, 1,4-dioxane, N,N-dimethylformamide, N-methyl-2-pyrrolidone and combinations thereof, to improve the cross-linking reaction yield.

11. The method as recited in claim 1, wherein the providing includes casting a solution of the linear perfluorinated polymer resin (in —SO₂—F form) and a carrier fluid into the reinforcement substrate and then removing the carrier fluid to deposit the linear perfluorinated polymer resin in the reinforcement substrate.

12. The method as recited in claim 1, wherein the providing includes melt-infiltrating the linear perfluorinated polymer resin (in —SO₂—F form) into the reinforcement substrate.

13. The method as recited in claim 11, further comprising converting, in-situ in the reinforcement substrate, a portion of the —SO₂F groups to —SO₂—NH₂ groups.

14. The method as recited in claim 13, wherein the converting includes exposing the reinforcement substrate that has the impregnated linear perfluorinated polymer resin (in —SO₂—F form) to ammonia gas.

15. The method as recited in claim 1, wherein the providing includes impregnating a solution of the linear perfluorinated polymer resin (in —SO₂—NH₂ form), at least one cross-linking agent and a carrier fluid into the reinforcement substrate, and then removing the carrier fluid to deposit the linear perfluorinated polymer resin (in —SO₂—NH₂ form) and at least one cross-linking agent in the reinforcement substrate.

16. The method as recited in claim 1, wherein the providing includes melt-infiltrating the linear perfluorinated polymer resin (in —SO₂—NH₂ form) and at least one cross-linking agent into the reinforcement substrate.

17. The method as recited in claim 15, wherein the at least one cross-linking agent is selected from the group consisting of F—SO₂—Rf—SO₂—F, NH₂—SO₂—Rf′—SO₂—NH₂ and combinations thereof, wherein Rf and Rf′ are independently selected from the group consisting of —(CF₂)ₙ— where n is 1-6 and —(CF₂)_{n′}—O—(CF₂)_{n′}— where n′ is 1-4.

18. The method as recited in claim 15, wherein the impregnating includes combining X moles of the F—SO₂—Rf—SO₂—F, Y moles of the NH₂—SO₂—Rf—SO₂—NH₂ and Z moles of the perfluorinated polymer resin (calculated by —SO₂—NH₂ groups) according to an equation X/(Y+0.5Z)≧1, where X, Y and Z are variable, X>0, Y≧0 and Z>0.
